(19) United States
(12) Patent Application Publication
(10) Pub. No.: US 2011/0101585 A1
(43) Pub. Date: May 5, 2011

(54) Shock absorber

(75) Inventor: Ryousuke Kamae, Yokohama (JP)

(73) Assignee: Hitachi Automotive Systems, Ltd., Kanagawa (JP)

(21) Appl. No.: 12/923,330

(22) Filed: Sep. 15, 2010

(30) Foreign Application Priority Data
Oct. 30, 2009 (JP) 2009-251055

(51) Int. Cl. B60G 15/06; F16F 13/00

(52) U.S. Cl. 267/226

(57) ABSTRACT

There is provided a shock absorber comprising: a cylinder; a piston slidably inserted into the cylinder; a piston rod penetrating a rod guide mounted on an end portion of the cylinder so as to extend externally; a damping force generator producing damping force through flow of the working fluid in which to be caused by sliding movement of the piston in the cylinder; and a rebound spring provided in the cylinder so as to restrict an extended-side stroke of the piston rod, wherein the rebound spring is provided at a periphery of the piston rod where one end of the rebound spring is fixed to a side of the cylinder while the other end thereof is a free-end facing a rebound stopper fixed on a side of the piston rod, and the free-end of the rebound spring is provided with an elastic member that slidably abuts to the piston rod.

### BACKGROUND OF THE INVENTION

1. Field of the Invention

The present invention relates to a shock absorber that is mounted on a suspension device, etc. of a vehicle.

2. Description of the Related Art

In a cylinder-shaped hydraulic shock absorber that is mounted on a suspension device of a vehicle such as an automobile, the following art is disclosed in Japanese Patent Publication Laid-open No. 2004-124993 (hereinafter referred to as “Patent Document 1”). That is, by providing a rebound spring, it is possible to modify shocks and impact sounds that occur when a rebound stopper fixed to the side of a piston collides against a rod guide fixed to the end portion of a cylinder in a condition where a piston rod is maximally extended. The rebound spring is a coil spring that is installed into the periphery of the piston rod placed between the rebound stopper and the rod guide. While the piston rod is being extended, but before maximal extension, the rebound spring starts to be compressed. Due to the spring force of the rebound spring, piston speed is adapted to slow down whereby the shocks and impact sounds that occur when the rebound stopper collides against the rod guide when the piston rod is maximally extended can be modified.

However, according to the art described in the Patent Document 1, there is a problem that, when the rebound spring is vibrated, vibration or noise tends to transmit toward a vehicle body through a spring bearing that is directly fixed to the piston rod.

### SUMMARY OF THE INVENTION

The present invention has been made in light of the above problem, and it is an object of the present invention to provide a shock absorber that maximally reduces vibration and noise of a rebound spring that is transmitted to a vehicle.

In order to achieve the object described above, according to an aspect of the present invention, there is provided a shock absorber comprising: a cylinder in which working fluid is filled; a piston that is slidably inserted into the cylinder; a piston rod that is connected with the piston and penetrates a rod guide mounted on an end portion of the cylinder so as to extend externally; a damping force generator that produces damping force through flow of the working fluid in which to be caused by sliding movement of the piston in the cylinder; and a rebound spring that is provided in the cylinder so as to restrict an extended-side stroke of the piston rod, wherein the rebound spring is provided at a periphery of the piston rod where one end of the rebound spring is fixed to a side of the cylinder while the other end of the rebound spring is a free-end that faces a rebound stopper fixed on a side of the piston rod, and the free-end of the rebound spring is provided with an elastic member that slidably abuts to the piston rod.

### BRIEF DESCRIPTION OF THE DRAWINGS

FIG. 1 is the longitudinal sectional view of a hydraulic shock absorber according to an embodiment of the present invention;

FIG. 2 is a longitudinal sectional view that expands the top end portion of a rebound spring of the hydraulic shock absorber of FIG. 1;

FIG. 3 is a longitudinal sectional view that expands the base end portion of the rebound spring of the hydraulic shock absorber of FIG. 1;

FIG. 4 is a longitudinal sectional view that expands the modified example of a spring guide in which to be mounted on the top end portion of the rebound spring of the hydraulic shock absorber of FIG. 1;

FIG. 5 is a longitudinal sectional view that expands another modified example of the spring guide in which to be mounted on the top end portion of the rebound spring of the hydraulic shock absorber of FIG. 1;

FIG. 6 is a longitudinal sectional view that expands modified examples of a spring bearing and a rod guide in which to be mounted on the base end portion of the rebound spring of the hydraulic shock absorber of FIG. 1;

FIG. 7 is a longitudinal sectional view that expands another modified example of the spring bearing and the rod guide in which to be mounted on the base end portion of the rebound spring of the hydraulic shock absorber of FIG. 1;

FIG. 8 is a longitudinal sectional view that expands the modified example of a piston portion of the hydraulic shock absorber of FIG. 1;

FIG. 9 is a longitudinal sectional view that expands modified examples of the rod guide and an oil sealing portion of the hydraulic shock absorber of FIG. 1; and

FIG. 10 illustrates Lissajous Waveform based on a damping force including friction in connection with the hydraulic shock absorber of FIG. 1.

### DETAILED DESCRIPTION OF THE PREFERRED EMBODIMENTS

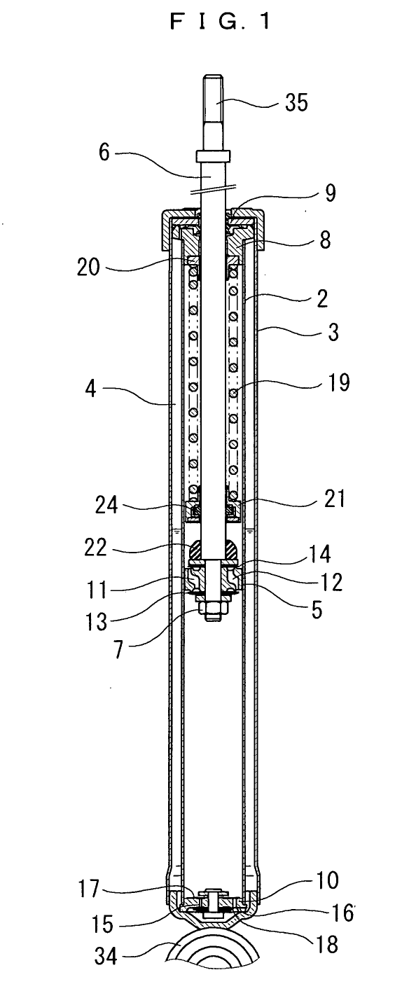

Embodiments of the present invention will be explained in detail with reference to the attaching figures. As shown in FIG. 1, the hydraulic shock absorber of embodiments in the present invention is categorized into an erecting twin-tube hydraulic shock absorber where an external cylinder 3 is provided at the external periphery of a cylinder 2, and a reservoir 4 is formed between the cylinder 2 and the external cylinder 3. In the interior of the cylinder 2, a piston 5 is slidably fitted, so that the piston 5 divides the interior of the cylinder 2 into two chambers, that is, a cylinder upper chamber 2A and a cylinder lower chamber 2B. One end of a piston rod 6 is connected with the piston 5 by means of a nut 7 while the other end of the piston rod 6 is inserted into a rod guide 8 and an oil seal 9 mounted on the upper end portion of the cylinder 2 and the external cylinder 3. The other end of the piston rod 6 thus externally projects from the upper end portion of the cylinder 2 by penetrating the rod guide 8 and the oil seal 9. Further, the other end of the piston rod 6 is mounted on a vehicle body through a mount. At the lower end portion of the cylinder 2, a base valve 10 is provided so as to partition the cylinder lower chamber 2B and the reservoir 4. Within the cylinder upper chamber 2A and the cylinder lower chamber 2B, oil fluid as working fluid is filled in, and within the reservoir 4, oil liquid and gas are filled in.

At the piston 5, a first extension passage 11 and a first compression passage 12 are provided so as to connect the cylinder upper chamber 2A with the cylinder lower chamber 2B. The first extension passage 11 and the first compression passage 12 are each provided with a first extension damping force generator 13 and a first compression damping force generator 14 that are composed of an orifice and a disk valve that generate damping force by controlling fluid flow of the first extension and compression damping force generators 13 and 14. Further, at the base valve 10, a second extension passage 15 and a second compression passage 16 are provided so as to connect the cylinder lower chamber 2B with the reservoir 4. The second extension passage 15 is provided with a check valve 17 that only allows the flow of the oil liquid from the reservoir 4 to the cylinder lower chamber 2B while the second compression passage 16 is provided with a second compression damping force generator 18 that is composed of an orifice and a disk valve in which to provide resistance against the flow of the oil liquid from the cylinder lower chamber 2B to the reservoir 4.

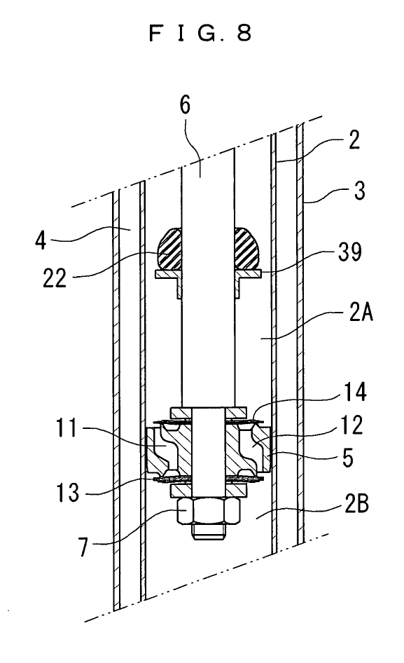

At the external periphery of the piston rod 6 within the cylinder upper chamber 2A, a rebound spring 19 is inserted. The rebound spring 19 has a base end portion (an upper end portion) that is fixed to the rod guide 8 by means of a spring bearing 20, and also has the other end portion (a lower end portion) that is a free end where a spring guide 21 attaches to the top end portion of the other end portion. The piston rod 6 is provided with an annual rebound stopper 22 made of an elastic member that is placed at a portion adjacent to the piston 5 and faces the spring guide 21 formed at the free end of the rebound spring 19. When the piston rod 6 extends up to a given position, the rebound stopper 22 abuts to the spring guide 21, and the rebound spring 19 is adapted to be compressed. As shown in FIG. 1, the rebound stopper 22 may be integrally provided with the piston 5 at a portion near the piston 5. Or, a piston portion may also work as the rebound stopper 22. Further, as described later, the rebound stopper 22 may be provided at a portion away from the piston 5 of the piston rod 6 (see FIG. 8). Here, in the present embodiments, as one of the examples, the rebound spring 19 is defined as that its free length is 120 mm, the diameter of linear material is 3.7 mm, and active coils are 17.5.

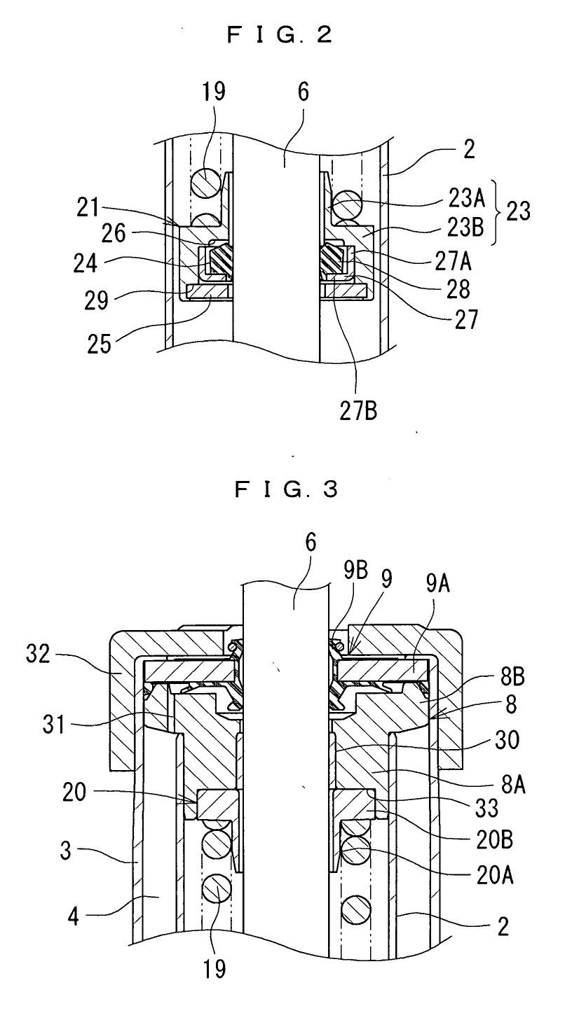

Next, with reference to FIG. 2, the top end structure of the rebound spring 19 to which the spring guide 21 is mounted will be explained in detail. As shown in FIG. 2, the spring guide 21 is composed of: a cylindrical main body case 23 with steps that has a convex contour formed by a small diameter portion 23A and a large diameter portion 23B; an annular elastic member 24 that is pressed into the main body case; and an annular abutting member 25 (an abutting portion) that is mounted on the end portion of the large diameter side of the main body case 23.

In the main body case 23, the small diameter portion 23A (a coupling portion) is press-fitted into the interior side of the rebound spring 19, and the stepped portion abuts to the end portion of the rebound spring 19 whereby the main body case 23 is mounted on the free end of the rebound spring 19. The top end portion of the small diameter portion 23A is tapered so as to ease the press-fitting of the small diameter portion into the rebound spring 19. Further, the tapered formation will prevent the small diameter portion 23A from interfering with the linear material when the rebound spring is extended/compressed. The inner diameter of the small diameter portion 23A is set to be slightly larger than the external diameter of the piston rod 6 so as not to contact to the external periphery of the piston rod 6. At the inner bottom portion of the large diameter portion 23B, an annular concave portion 26 is formed at the circumference of an opening into which the piston rod 6 is inserted.

The elastic member 24 is formed as that an annular elastic body 28 such as nitrile rubber, etc. having elastic or viscoelastic characters is fixed to the interior of a retainer 27 that is, for example, composed of a cylindrical portion 27A and a flange portion 27B extending from the one end portion of the cylindrical portion 27A in its inner radial direction, the retainer 27 being formed, for example, with rigid-metal annular members. The elastic member 24 is fixed by press-fitting the cylindrical portion 27A of the retainer 27 into the large diameter portion 23B of the main body case 23. Further, the elastic member 24 is positioned in the axial direction of the piston rod 6 by abutting the end portion of the retainer 27 against the bottom portion of the large diameter portion 23B. With this structure discussed above, there is no interference with the elastic body 28 due to the concave portion 26 placed on the bottom portion of the large diameter portion 23B that works as runout. The lateral wall of the end portion of the large diameter portion 23B that is an opposite side relative to the small diameter portion 23A is thinned whereby the large diameter portion has a stepped portion 29 at the inner periphery thereof. The abutting member 25 is fitted into the thinned portion so as to abut against the stepped portion 29 thereby being positioned in the axial direction of the piston rod 6. Further, the top end of the thinned portion is caulked in a radially inside direction so as to fix the abutting member 25. Here, a slight clearance is formed between the retainer 27 of the elastic member 24 and the abutting member 25 in the axial direction of the piston rod 6, whereby axial loads applied to the abutting member 25 will be received with the stepped portion 29 thereby prohibiting the load from being transmitted to the elastic member 24. The inner diameter of the abutting member 25 is set to be slightly larger than the outer diameter of the piston rod 6 whereby the inner diameter of the abutting member 25 is formed not to contact to the outer diameter of the piston rod 6. The elastic body 28 of the elastic member 24 is formed so as to allow that the piston rod 6 is slidably inserted into the elastic body 28 with a certain interference thereby applying a given frictional force when the piston rod 6 is shifted.

Next, with reference to FIG. 3, the structure of the base end portion of the rebound spring 19 that is fixed to the spring bearing 20 will be explained in detail. The rod guide 8 is composed of: a small diameter portion 8A that is fitted into the cylinder 2; and a large diameter portion 8B that is fitted into the external cylinder 3, whereby the rod guide 8 is formed into a stepped cylinder. An annular retaining portion 9A of the oil seal 9 abuts to the upper end portion of the rod guide 8, and is fixed by making the top end portion of the external cylinder 3 caulked in a radial direction. At the inner periphery of the rod guide 8, a bush 30 is press-fitted so as to make the piston rod 6 to be slidably guided. In the oil seal 9, by means of a lip-shaped sealing member 9B that is fixed to the retaining portion 9A, the sliding surface of the piston rod 6 as well as a space defined between the external cylinder 3 and the rod guide 8 are sealed. At the large diameter portion 8B of the rod guide 8, a drainage passage 31 penetrates along the axial direction of the piston rod 6 whereby oil liquid leaking between the large diameter portion 8B and the oil seal 9 through the bush 30 can return to the reservoir 4. In addition, at the upper end portion of the external cylinder 3, a cap 32 is externally fitted so as to protect the oil seal 9.

At the top end of the small diameter portion 8A of the rod guide 8 that is fitted into the cylinder 2, an annular concave region 33 is formed, and the spring bearing 20 is press-fitted into the concave region 33. The spring bearing 20 has a convex appearance that is composed of a small diameter portion 20A and a large diameter portion 20B, the spring bearing 20 thus being formed into a stepped cylinder. Further, the spring bearing 20 has an opening at its center portion into which the piston rod 6 is inserted with a given clearance. In the spring bearing 20, the large diameter portion 20B is press-fitted into the concave region 33 of the rod guide 8 while the top end portion of the rebound spring 19 is externally press-fitted into the small diameter portion 20A. Still further, the top end portion of the rebound spring 19 abuts to the stepped portion for fixation. The top end portion of the small diameter portion 20A is tapered whereby it facilitates the press-fitting of the small diameter portion 20A into the rebound spring 19, and the tapered formation can also prevent the small diameter portion 20A from interfering with the linear material when the rebound spring 19 is extended/compressed.

A stroke end on a side where the piston rod 6 extends can be defined, for example, based on that the rebound stopper 22 compresses the rebound spring 20, and their line materials abut to each other so as to restrict the shift of the piston rod 6. In this case, in order to reduce shock and striking sounds generated through the contact of the line materials by each other, it is preferable that the surface of the line materials is covered or coated with shock-absorbing materials such as rubber, etc. In addition to the above, it is also possible to define the stroke end based on that some kinds of stopper restricting stroke on a side where the piston rod 6 extends may be provided.

At the bottom portion, that is, at the lower end portion of the external cylinder 3, a mounting eye portion 34 is provided so as to connect to suspension materials on a vehicle wheel side (lower side of a spring), and at the top end portion of the piston rod 6, a mounting portion 35 (screw portion) is formed so as to connect to a vehicle body side (upper side of a spring).

The functions of the embodiments in the present invention as discussed will be explained below. In a process where the piston rod 6 extends, along with the slide of the piston 5 within the cylinder 2, oil liquid on the side of the cylinder upper chamber 2A is pressurized, so that the oil liquid is adapted to flow toward the cylinder lower chamber 2B by passing through the first extension passage 11 and the extension damping force generator 13 of the piston 5. Accordingly, damping force will be generated due to the extension damping force generator 13. Here, oil liquid in which to exit from the cylinder 2 flows from the reservoir 4 to the cylinder lower chamber 2B by opening the check valve 17 of the second extension passage 15 of the base valve 10. Then, by making gas within the reservoir 4 expanded, volumetric compensation will be performed according to volumetric changes in the cylinder 2.

On the other hand, in a process where the piston rod 6 compresses, along with slide of the piston 5 within the cylinder 2, oil liquid on the side of the cylinder lower chamber 2B is pressurized, so that the oil liquid is adapted to flow toward the cylinder upper chamber 2A by passing through the first compression passage 12 and the first compression damping force generator 14 of the piston 5. Accordingly, damping force will be generated due to the first compression damping force generator of the piston 5. Further, since the piston rod 6 is introduced into the cylinder 2, the oil liquid staying in the cylinder lower chamber 2B is adapted to flow toward the reservoir 4 by passing through the second compression passage 16 of the base valve 10 whereby damping force will be generated due to the second compression damping force generator 18. Both of the damping forces in total will be then the damping force during the compression process. Here, since gas in the reservoir 4 that corresponds to an amount where the piston rod 6 is introduced into the cylinder 2 is compressed, it is possible to perform volumetric compensation according to volumetric changes in the cylinder 2.

Then, in a process where the piston rod 6 extends, the rebound stopper 22 abuts against the abutting member 25 of the spring guide 21. Accordingly, the rebound spring 19 compresses relative to the stroke of the piston rod 6 whereby spring force can work as resistive force. Since this spring force expands in proportion with the compression of the rebound spring 19, it is possible to decelerate stroke speeds so as to modify shocks when the piston rod 6 reaches to its stroke end. Further, by applying the spring force of the rebound spring 22 to the piston rod 6, it is possible to reduce resonance of the piston rod 6 so as to minimize generation of uncomfortable sounds due to the resonance.

In a condition where the rebound stopper 22 does not abut to the spring guide 21 (see FIG. 1), the bottom end portion of the rebound spring 19 becomes a free-end. However, since the bottom end portion of the rebound spring 19 is slidably guided along the piston rod 6 by means of the elastic member 24 of the spring guide 21 and restrained in its radial direction, the rebound spring 19 will never be in contact with the outer periphery of the piston rod 6 or the inner periphery of the cylinder 2 so as not to generate uncomfortable noises. Further, the rebound spring 19 is mounted on the rod guide 8 that is fixed on the side of the cylinder 2 connected to the wheel side (lower side of a spring) of a vehicle, and the elastic member 24 is provided at the piston rod 6 connected to the side of the vehicle (upper side of a spring). Accordingly, even if the rebound spring 19 is resonated, vibrations and noises that may be generated would be hardly transmitted to the side of the vehicle body thereby being able to enhance riding comfortability and quietness.

Here, it may be possible to prevent the generation of impact sounds causing through interference of the piston rod and cylinder as that: for example, the base end portion of the rebound spring is fixed on the side of the piston rod; the spring guide is mounted on the top end portion of the rebound spring; and the elastic member installed to the spring guide is adapted to slide on the interior wall of the cylinder so as to inhibit the rebound spring from swaying in its lateral direction. However, with this structure, since the base end portion of the rebound spring is fixed on the side of the piston rod, noises where vibrations generated at the rebound spring resonates are transmitted to the vehicle body through the piston rod that connects to the side of the vehicle body. This problem still remains. To the contrary, by applying the embodiments of the present invention, it is possible to achieve positive effects that vibrations and noises are hard to be transmitted to the side of the vehicle body.

When the piston rod 6 performs slight strokes, damping force generated at the extension damping force generator, the first compression damping force generator and the second compression damping force generator through flow of oil liquid may cause a late engine response due to the deformation of sealing portions, the compression/expansion of oil liquid, etc. in the cylinder 2. On the other hand, frictional force between the piston rod 6 and the elastic member 24 of the spring guide 21 will quickly start by the slide of these members. Accordingly, it is possible to compensate the late response of damping force generation due to the flow of oil liquid when the piston rod 6 performs the slight strokes, thereby being able to produce proper damping force.

FIG. 10 is an illustration where the frictional force of the elastic member 24 generates. Here, since this illustration is only an image, a stroke position has not been considered. An abscissa axis indicates a stroke range while a longitudinal axis indicates an axial force (frictional force and damping force). In FIG. 10, solid lines indicate, as shown in Japanese Patent Publication Laid-open No. 2007-205435, the waveform of a hydraulic shock absorber where an elastic member is fixed to a retainer fixing to a rod guide that is still and secured. On the other hand, broken lines indicate the waveform of the hydraulic shock absorber 1 according to the embodiments of the present invention where damping force by the frictional force of the elastic member 24 is applied. In a case where the elastic member is arranged through fixation, axial force to be generated due to frictional force will be sharply changed when converting from extension processes to compression processes or otherwise (hereinafter referred to as the converting processes). To the contrary, in the present invention, since the elastic member 24 is fixed to the spring guide 21 that is axially movable, in a case where the setting relation of static friction between the spring counterforce of the rebound spring and the elastic member 24 is in a condition that the static friction is greater than the spring counterforce, the axial force to be generated due to the frictional force will increase gradually during the converting processes whereby the axial force can be moderately changed when the converting processes are proceeded. Further, in the hydraulic shock absorber 1 of the present embodiments, by compensating the damping force due to oil liquid flow with frictional force, not only stable damping characters become obtainable but also a size of the frictional force applied or active strokes may become adjustable by changing the sizes or characters of the elastic member and the rebound spring.

As discussed above, since the spring force of the rebound spring 19 and the frictional force of the elastic member 24 are applied to the damping force due to oil liquid flow, it would be possible to change the damping characters by optionally setting frictional force characters such as: sizes, materials, and linearity of the rebound spring 19; spring characters by nonlinearity, etc.; materials, formations and interferences of the elastic material 24; and surface roughness of the piston rod 6, etc. thereby improving tuning flexibility. Here, when the piston rod 6 is in its extension process, the spring guide 21 shifts together with the piston rod 6 after the spring guide 21 abuts to the rebound stopper 22 whereby the frictional force by the elastic member 24 becomes non-applicable to the strokes of the piston rod 6. Accordingly, it becomes possible to adjust damping characters according to the strokes of the piston rod 6. For example, when a vehicle travels on a well-conditioned road, that is, needs relatively small strokes, the frictional force by the elastic member 24 will be applied. On the other hand, when the vehicle travels on a poor-conditioned road, that is, needs relatively large strokes, it becomes adjustable not to apply the friction force by the elastic member 24. Accordingly, it would be possible to offer more opportunities for tuning damping characters in order to improve riding comfortability and operational stability.

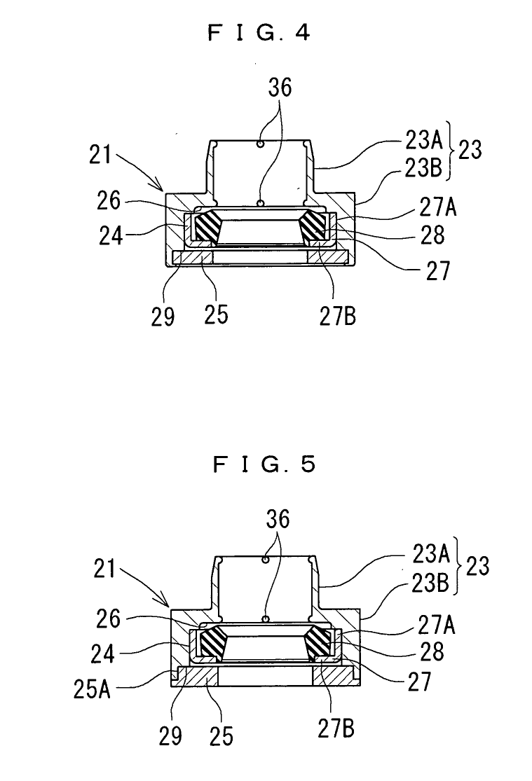

Next, some modified examples of the above embodiments according to the present invention will be explained with reference to FIGS. 4 to 9. Here, the same reference numerals will be applied to parts identical with the above embodiments, and parts not identical with the above embodiments will be explained with reference to figures in detail.

In the modified examples as shown in FIG. 4, considering the spring guide 21, a plurality of projection portions 36 are arranged on the internal surface of the small diameter portion 23A of the main body case 23 with equal intervals along the circumferential direction of the internal surface, the plurality of projection portions 36 being arranged at either end of the small diameter portion 23A in the axial direction of the piston rod 6. Accordingly, clearance defined between the projection portions 36 and the piston rod 6 becomes narrowed. With this structure, even if the rebound spring 19 is compressed, and the spring guide 21 is inclined, the projection portions 36 are adapted to abut to the piston rod 6 whereby it is possible to minimize the inclination of the spring guide 21. Further, since there is a normally slight clearance between the projection portions 36 and the piston rod 6, there is no necessity to worry about transmission of vibrations and noises therebetween.

In the modified example as shown in FIG. 5, considering the spring guide 21, the abutting member 25 is fixed to the main body case 23 through not caulking but press-fitting. The abutting member 25 is formed into a stepped cylinder. The small diameter portion 25A of the abutting member 25 is press-fitted into the thinned portion of the large diameter portion 23B of the main body case 23, and the stepped portion of the abutting member 25 abuts to the end portion of the main body case 23 for fixation.

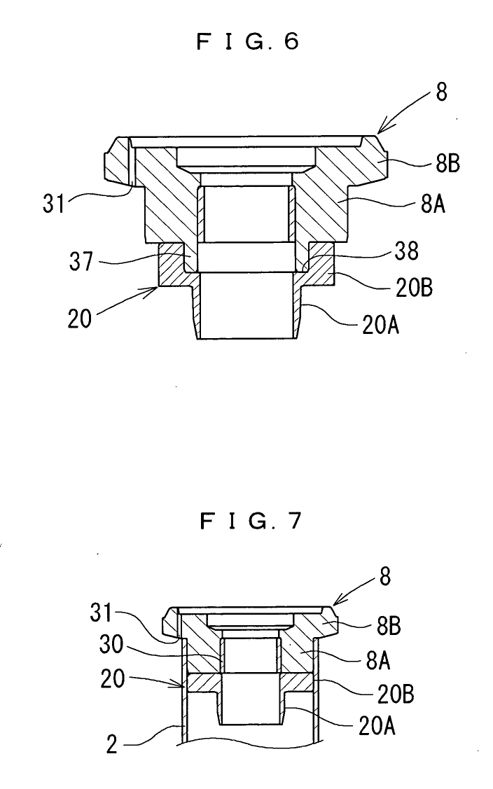

In the embodiments of FIG. 6, considering the rod guide 8, at the periphery of the opening into which the piston rod 6 is to be inserted, a cylindrical convex portion 37 instead of the annular concave portion 33 is formed. By press-fitting the convex portion 37 into an annular concave part 38 formed on a side of the spring bearing 20, the spring bearing 20 is fixed to the rod guide 8.

In the modified example as shown in FIG. 7, the annular concave portion 33 of the rod guide 8 is removed, and the large diameter portion of the spring bearing 20 is press-fitted into the cylinder 2 and abuts to the end portion of the rod guide 8 for fixation.

In the modified example as shown in FIG. 8, the rebound stopper 22 is fixed at a portion away from the piston 5 by means of a convex retaining portion 39 mounted on the piston rod 6. With this structure, it is possible for the rebound stopper 22 to adjust the stroking position of the piston rod 6 that abuts to the spring guide 21.

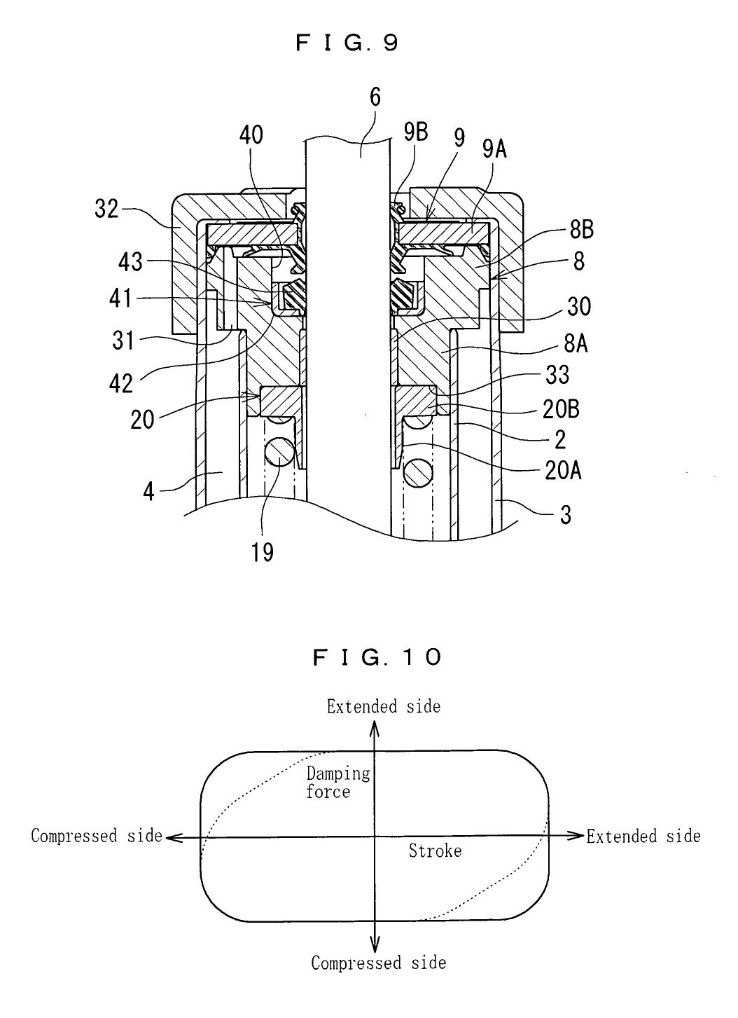

In the modified embodiment as shown in FIG. 9, an annular concave region 40 is formed at the end portion of the large diameter portion 8B of the rod guide 8 into which the piston rod 6 is inserted. An elastic member 41 structured as the same with the elastic member 24 of the spring guide 21 is press-fitted into the concave region 40. Then, the piston rod 6 is slidably inserted into an elastic body 43 fixed to a retainer 42 of the elastic member 41 with a given interference thereby providing a predetermined frictional force against the shift of the piston rod 6. With this structure, the frictional force of the elastic member 41 becomes normally applicable to the strokes of the piston rod 6 in addition to the frictional force of the elastic body 28 of the spring guide 21. By applying these frictional forces, it is possible to enhance tuning flexibilities of the damping characters.

In the above embodiments, the hydraulic shock absorber 1 is defined as a double-tube type where the reservoir 4 is provided around the outer periphery of the cylinder 2, and oil liquid and gas are applied as working fluid in the light of operational stability and easy handling. However, the present invention is not limited thereto. It is possible to apply a single-tube type shock absorber or to use oil liquid, air or nitrogen gas as the working fluid either in an individual manner or a combined manner.

Further, in the present embodiments, a standing type where the side of the piston rod is mounted to a vehicle body is applied; however, in case that effects of the frictional force by the elastic member 41 are focused, an inverted type where the piston rod is mounted to the side of wheels may be applied.

What is claimed is:

1. A shock absorber comprising:
a cylinder in which working fluid is filled;
a piston that is slidably inserted into the cylinder;
a piston rod that is connected with the piston and penetrates a rod guide mounted on an end portion of the cylinder so as to extend externally;
a damping force generator that produces damping force through flow of the working fluid in which to be caused by sliding movement of the piston in the cylinder; and
a rebound spring that is provided in the cylinder so as to restrict an extended-side stroke of the piston rod,
wherein the rebound spring is provided at a periphery of the piston rod where one end of the rebound spring is fixed to a side of the cylinder while the other end of the rebound spring is a free-end that faces a rebound stopper fixed on a side of the piston rod, and the free-end of the rebound spring is provided with an elastic member that slidably abuts to the piston rod.

2. The shock absorber according to claim 1, wherein the elastic member includes an elastic body made of nitrile rubber that slidably abuts to the piston rod.

3. The shock absorber according to claim 1, wherein the free-end of the rebound spring is provided with a spring guide that abuts to the rebound stopper, the elastic member is provided within the spring guide, and clearance is provided between the spring guide and piston rod.

4. The shock absorber according to claim 3, wherein the spring guide is provided with a connective portion at one end side thereof in which to be connected to the free-end of the rebound spring, and the spring guide is also provided with an abutting portion at the other end side thereof in which to abut to the rebound stopper.

5. The shock absorber according to claim 1, wherein the rebound stopper is integrally formed with the piston.

6. The shock absorber according to claim 1, wherein the rebound stopper is arranged at a portion away from the piston.

7. The shock absorber according to claim 4, wherein the spring guide is composed of a small diameter portion that is connected with the free-end of the rebound spring and a large diameter portion that abuts to the rebound stopper, the spring guide being formed into a convex shape.

8. The shock absorber according to claim 4, wherein the elastic member is composed of a rigid annular member including a cylindrical portion into which the piston rod is inserted and a flange portion extending from the cylindrical portion to a direction radially inside; and an elastic body that is fixed to an inner periphery of the annular member, and the annular member is fixed to a main body case.

9. The shock absorber according to claim 8, wherein clearance is formed between the cylindrical portion and the elastic body.

10. The shock absorber according to claim 1, wherein one end side of the rebound spring is fixed to the rod guide.
